(19) United States
(12) Patent Application Publication
(10) Pub. No.: US 2025/0129754 A1
(43) Pub. Date: Apr. 24, 2025

(54) ENGINE CONTROL COMPUTER

(71) Applicant: Vitesco Technologies GmbH, Regensburg (DE)

(72) Inventors: Pascal ROCHARD, Toulouse (FR); Stéphane ELOY, Toulouse (FR)

(21) Appl. No.: 18/688,867

(22) PCT Filed: Sep. 2, 2022
(86) PCT No.: PCT/EP2022/074487

§ 371 Date: Mar. 4, 2024

(30) Foreign Application Priority Data
Sep. 10, 2021 (FR) 2109509

(51) Int. Cl. F02D 41/22

(52) U.S. Cl. CPC F02D 41/222; F02D 2400/14

(57) ABSTRACT

A computer for a motor vehicle able to be electrically connected to a sensor of the vehicle over a wired communication link in order to receive an output signal generated by the sensor. The sensor being electrically powered by a power supply module via a wired power supply link. The computer is able to be electrically connected to a measurement device configured for measuring the variations in the electric current flowing through the wired power supply link, and it is configured for detecting a short-circuit on the wired communication link between the wired power supply link and the wired communication link, for receiving, from the measurement device, the measurements of the variations in the current flowing between the power supply module and the sensor and for estimating the output signal from the received current variation measurements.

### CROSS REFERENCE TO RELATED APPLICATIONS

This application is the U.S. National Phase Application of PCT International Application No. PCT/EP2022/074487, filed Sep. 2, 2022, which claims priority to French Patent Application No. 2109509, filed Sep. 10, 2021, the contents of such applications being incorporated by reference herein.

### FIELD OF THE INVENTION

The invention relates to the field of combustion engines for motor vehicles and more specifically to the field of computers for controlling a combustion engine of a motor vehicle.

### BACKGROUND OF THE INVENTION

As is known, a combustion engine of a motor vehicle comprises hollow cylinders that each delimit a combustion chamber into which a mixture of air and fuel is injected. This mixture is compressed in the cylinder by a piston and ignited so as to make the piston translationally move inside the cylinder.

The movement of the pistons in each cylinder of the engine sets into rotation an engine shaft, called “crankshaft”, allowing the wheels of the vehicle to rotate via a transmission system.

The vehicle also comprises a system for controlling the combustion engine for controlling the injection of fuel into each combustion chamber as a function of the torque command issued by the driver.

Nowadays, the system for controlling the combustion engine comprises a crankshaft sensor and a control unit. The sensor is installed facing a toothed target fixed to the crankshaft and measures the variations in the magnetic field that are generated by the teeth passing in front of the sensor. The sensor thus generates a square-wave signal that it sends to the control unit over a first wired link. The control unit can thus determine the angular position of the crankshaft in order to determine the appropriate command to be sent to each injector at the appropriate time.

The control unit is also able to supply the sensor with electric power via a second wired link separate from the first wired link. For example, the control unit comprises a power supply device, electrically connected to the sensor via the second wired link.

However, a short-circuit can occur between the first wired link and the second wired link. In this case, the sensor is no longer able to generate the square-wave signal and transmit it to the control unit via the first wired link. As is known, the control unit detects this malfunction and activates a degraded mode, in which the torque demand would be limited. In some cases, the control unit could also ask the driver to stop the vehicle as quickly as possible. Activation of the degraded modes described above can be disruptive for the vehicle user.

Thus, a requirement exists for a solution that allows these disadvantages to be at least partly overcome.

### SUMMARY OF THE INVENTION

To this end, an aspect of the invention relates to a computer for a motor vehicle, said computer being able to be electrically connected to a sensor of the vehicle over a wired communication link in order to receive an output signal generated by said sensor, said sensor being electrically powered by a power supply module via a wired power supply link, the computer being characterized in that it is configured for:
being electrically connected to a measurement device by a wired measurement exchange link, said measurement device being configured for measuring the variations in the electric current flowing through the wired power supply link;
detecting an anomaly on the wired communication link relating to a short-circuit between the wired power supply link and the wired communication link;
receiving, from the measurement device, measurements of the variations in the current flowing between the power supply module and the sensor when an anomaly is detected;
estimating the output signal from the current variation measurements received over the wired measurement exchange link.

Thus, even when a short-circuit occurs between the wired power supply link and the wired communication link, the wired power supply link allows the sensor to be supplied with current. In this way, the sensor continues to operate normally and the computer can receive the information measured by the sensor via the measurement device. Notably, when the computer is an engine control computer, when the sensor is a crankshaft sensor and a short-circuit occurs, the computer is still able to determine the position and the speed of rotation of the crankshaft from the information measured by the measurement device. The computer then controls the injection of fuel into each combustion chamber of the engine as a function of the determined position and speed of rotation of the crankshaft. Thus, the engine can operate normally, whether or not there is a short-circuit between the wired power supply link and the wired communication link.

An aspect of the invention also relates to a motor vehicle comprising:
a) a sensor comprising a power supply connector and an output connector via which the sensor is able to generate an output signal;
b) a power supply module able to supply a power supply voltage, electrically connected to the power supply connector by a wired power supply link;
c) a current measurement device, able to measure the variation in current between the power supply module and the power supply connector;
d. a computer as described above.

Preferably, the vehicle comprises a multiplexer, said multiplexer comprising:
a. a first input electrically connected to the output connector;
b. a second input electrically connected to the current measurement device;
c. an output electrically connected to the computer;
d. a selection input connected to the computer;
   the computer being configured for:
a. transmitting, when a short-circuit is detected, a command to the selection input of the multiplexer, notifying said multiplexer to connect the second input to the output of the multiplexer;
b. receiving the variation in the current between the power supply module and the power supply connector measured by the measurement device and transmitted via the multiplexer.

Thus, the multiplexer easily allows the computer to be connected to the output connector when no short-circuit is detected and to the measurement device when a short-circuit is detected.

More preferably, the vehicle comprises a pull-up resistor connected between a power supply terminal and the output connector of the sensor, said power supply terminal being able to supply a second power supply voltage with a value that is equal to the power supply voltage supplied by the power supply module.

The generated output signal varies between a low voltage level and a high voltage level, for which the voltage is higher than that of the low level. The pull-up resistor allows the value of the high voltage level to be imposed when the output signal is supplied by the sensor via the output connector.

Preferably, the vehicle comprises a ground, the sensor comprising a ground connector electrically connected to the ground.

Advantageously, the sensor comprises a bipolar transistor, the collector of which is electrically connected to the output connector by a protective resistor and the transmitter of which is connected to the ground connector.

Advantageously, according to another embodiment, the sensor comprises a MOSFET transistor, the drain of which is electrically connected to the output connector by a protective resistor and the source of which is connected to the ground connector.

An aspect of the invention also relates to a method for estimating an output signal, implemented by a vehicle as described above, said method comprising the steps of:
a. detecting an anomaly on the wired communication link relating to a short-circuit between the wired power supply link and the wired communication link;
b. receiving measurements of the variation in the current flowing between the power supply module and the sensor when an anomaly is detected;
c. estimating the output signal from the current variation measurements received over the wired measurement exchange link.

Thus, in the event of a short-circuit being detected between the wired power supply link and the wired communication link, the method allows the computer to be provided with a current variation, so that said computer is able to estimate the output signal. In this way, even in the event of a short-circuit, the computer has access to the information measured by the sensor. Notably, when the computer is an engine control computer, when the sensor is a crankshaft sensor and a short-circuit occurs, the computer is still able to determine the position and the speed of rotation of the crankshaft from the information measured by the measurement device. The computer then controls the injection of fuel into each combustion chamber of the engine as a function of the determined position and speed of rotation of the crankshaft. Thus, the engine can operate normally, whether or not there is a short-circuit between the wired power supply link and the wired communication link.

### BRIEF DESCRIPTION OF THE DRAWINGS

Further features and advantages of aspects of the invention will become more clearly apparent upon reading the following description. This description is purely illustrative and should be read with reference to the appended drawings, in which:

FIG. 1 is a schematic representation of an embodiment of the vehicle according to the invention;

FIG. 2 is a schematic illustration of a second embodiment of the vehicle according to the invention.

### DETAILED DESCRIPTION OF THE PREFERRED EMBODIMENTS

An embodiment of the vehicle according to the invention will now be described.

The vehicle comprises a combustion engine. The combustion engine comprises a plurality of cylinders, a crankshaft and at least one camshaft. Even more specifically, in this non-limiting example, the combustion engine comprises a row of cylinders connected to a camshaft and to the crankshaft.

Each cylinder is hollow and delimits a combustion chamber in which a piston slides. A mixture of air and fuel, introduced into the combustion chamber, is compressed by the piston. The mixture ignites and causes the piston to translationally move inside the cylinder. In addition, each cylinder is connected to the crankshaft via its piston.

Each cylinder comprises an intake valve, through which the gases are introduced into the combustion chamber, and an exhaust valve, through which the gases are expelled from the combustion chamber. The intake valve and the exhaust valve are connected to the camshaft of the corresponding row of cylinders.

A toothed target is fixed to the crankshaft. The target also can be magnetic.

In yet another embodiment, the toothed or magnetic target can be fixed to a camshaft.

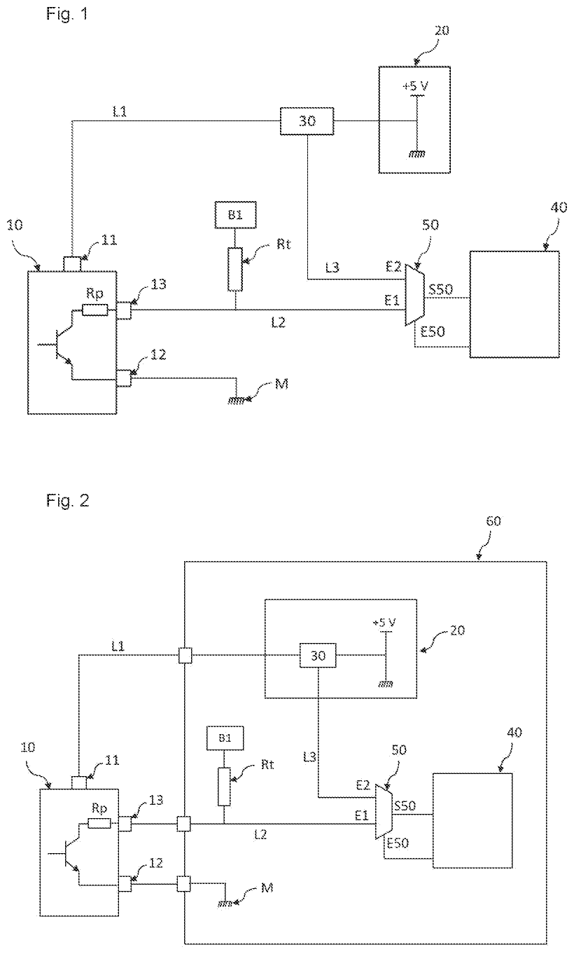

With reference to FIG. 1, the vehicle also comprises a sensor 10, a power supply module 20, at least one ground M, a current measurement device 30 and an engine control computer 40.

The power supply module 20 is able to supply a power supply voltage. The power supply voltage is set to +5 Volts, for example.

The sensor 10 comprises a power supply connector 11, a ground connector 12 and an output connector 13.

The power supply connector 11 is electrically connected to the power supply module 20, by a wired power supply link L1, thus allowing the sensor 10 to be supplied with electric power. The ground connector 12 is electrically connected to the ground M. Finally, the sensor 10 is able to generate an output signal via the output connector 13.

More specifically, the output signal corresponds to a square-wave signal regularly alternating between a “high” level and a “low” level. The voltage corresponding to the high level is higher than the voltage corresponding to the low level. Notably, the low level voltage is close to 0 volts and the high level voltage corresponds to the voltage supplied by the power supply module 20, notably +5 volts.

The sensor 10 can be mounted, for example, in the vehicle so as to be disposed facing said target. The output signal therefore relates to said target.

In addition, the sensor 10 also comprises a magnetic field level detection device. The output signal therefore relates to the magnetic field level measured by the detection device when a tooth of the toothed target passes in front of the sensor 10.

For example, for a toothed target fixed to the crankshaft, each high level of the output signal corresponds to the passage of a tooth of the target in front of the sensor 10 and each low level corresponds to the passage of a space between two consecutive teeth of the target in front of the sensor 10.

Still with reference to FIG. 1, the sensor 10 comprises, for example, an NPN bipolar transistor, the collector of which is electrically connected to the output connector 13 by a protective resistor Rp and the transmitter of which is connected to the ground connector 12. In addition, the base of the NPN bipolar transistor is connected to the magnetic field level detection device. In other words, the base of the transistor is controlled by the magnetic field level detection device. Even more specifically, in this case this is a bipolar transistor with an “open collector” assembly, known to a person skilled in the art.

According to another embodiment of the sensor 10, not shown in the figures, the sensor 10 comprises a MOSFET transistor, the drain of which is electrically connected to the output connector 13 by a protective resistor Rp and the source of which is connected to the ground connector 12. The gate of the MOSFET transistor is connected to the magnetic field level detection device. In other words, the transistor gate is controlled by the magnetic field level detection device.

The bipolar or MOSFET transistor acts like a closed switch when the output signal is low and like an open switch when the output signal is high.

The vehicle also comprises a pull-up resistor Rt electrically connected between the output connector 13 and a power supply terminal B1. The power supply terminal B1 is able to supply a second power supply voltage, notably equal to that supplied by the power supply module 20. In other words, the pull-up resistor Rt is connected between the collector, or drain, of the transistor of the sensor 10 and the power supply terminal B1.

When the transistor of the sensor 10 acts like an open switch, the pull-up resistor Rt notably allows the high voltage level of the output signal to be imposed that is generated at the output connector 13.

When the transistor of the sensor 10 is saturated, in other words when the sensor 10 acts like a closed switch, the pull-up resistor Rt is connected to the ground M and allows the low level voltage resulting from the saturation of the transistor to be defined.

The current measurement device 30 is electrically connected to the wired power supply link L1. In other words, the current measurement device 30 is configured to measure the variations in the electric current flowing through the wired power supply link L1.

More specifically, according to a first embodiment, the measurement device 30 acquires a measurement signal corresponding to a variation in voltage proportional to the variation in the current flowing through the wired power supply link L1.

According to a second embodiment, the measurement device 30 acquires a measurement signal directly corresponding to the variation in the current flowing through the wired power supply link L1.

The measurement signal corresponds to a square-wave signal regularly alternating between a “high” state and a “low” state. The value measured for a low state is lower than the value measured for a high state. In a high state, the transistor of the sensor 10 acts like an open switch. In a low state, the transistor of the sensor 10 acts like a closed switch, in other words the transistor is saturated, and an overcurrent, detectable by the measurement device 30, occurs between the power supply module 20 and the power supply connector 11.

Thus, the shape of the measurement signal, as voltage or as current, representing the variation in current in the wired power supply link L1 is similar to that of the voltage output signal. Notably, the frequency, respectively the pulse width of each square wave, of the measurement signal corresponds to the frequency, respectively to the pulse width of each square wave, of the output signal. Thus, the measurement signal also faithfully represents the operation of the sensor 10, as does the output signal when there is no short circuit.

Furthermore, according to a first embodiment of the measurement device 30, the measurement signal varies between 0 volts and the second supply voltage provided by the power supply terminal B1. In other words, in the present case, the value of the low state corresponds to 0 volts and the value of the high state corresponds to +5 volts.

The measurement device 30 is also electrically connected to the computer 40 via a wired measurement exchange link L3. The measurement device 30 is thus able to send the measurement signal to the computer 40 via the wired measurement exchange link L3.

The vehicle also comprises a multiplexer 50. The multiplexer 50 comprises a first input E1, a second input E2, a selection input E50 and an output S50. The first input E1 is electrically connected to the output connector 13. The second input E2 is electrically connected to the current measurement device 30, and the output S50 is electrically connected to the computer 40. Finally, the selection input E50 is also connected to the computer 40.

The multiplexer 50 is able to electrically connect the output S50 to the first input E1 or the second input E2.

The multiplexer 50 is able to be controlled by the computer 40, via the selection input E50, in order to know whether the multiplexer 50 should connect the first input E1 or the second input E2 to the output S50.

The computer 40 is electrically connected to the output connector 13 of the sensor 10 by a wired communication link L2. Thus, the computer 40 is able to receive the output signal generated by the sensor 10 via the wired communication link L2. Moreover, the computer 40 is connected to the measurement device 30 via the wired measurement exchange link L3, in order to receive the variation in current measured by the measurement device 30.

Furthermore, the computer 40 is also configured to control the multiplexer 50. To this end, the computer 40 is configured to transmit a command to the selection input E50 of the multiplexer 50, with the command comprising a set of instructions notifying the multiplexer 50 to connect the output S50 to the first input E1 or to the second input E2.

In addition, when a short-circuit occurs between the wired power supply link L1 and the wired communication link L2, then the output connector 13 is connected to the power supply module 20 and the voltage at the output of the output connector 13 corresponds to a DC voltage, equal to the voltage supplied by the power supply module 20.

The computer 40 is configured to detect an anomaly on the wired communication link L2 relating to a short-circuit between the wired power supply link L1 and the wired communication link L2. To this end, the computer 40 is able to detect when the voltage of the received output signal corresponds to a DC voltage with a value equal to the voltage supplied by the power supply module 20 and, at the same time, the computer 40 receives information informing it that at least one tooth of the target has passed in front of the sensor 10.

When a short-circuit is detected, the computer 40 is also configured to transmit a command to the selection input E50 of the multiplexer 50, notifying said multiplexer 50 to connect the second input E2 to the output S50 of the multiplexer 50, and therefore to disconnect the first input E1 from the output S50.

By default, when no short circuit is detected by the computer 40, the output S50 of the multiplexer 50 is connected to the first input E1 of the computer 40 and not to the second input E2.

In addition, when an anomaly, notably a short-circuit, is detected, the computer 40 is configured to receive the measurement signal from the measurement device 30 that represents the variation in the current flowing between the power supply module 20 and the sensor 10. More specifically, the computer 40 receives the measurements of the variations in the current via the measurement exchange link L3.

Finally, the computer 40 is configured to estimate the output signal from the measurement signal received via the wired measurement exchange link L3.

More specifically, when the measurement device 30 corresponds to the first embodiment, the computer 40 directly receives a voltage variation, proportional to the current variation on the wired power supply link L1.

When the measurement device 30 corresponds to the second embodiment, the computer 40 converts the received measured current variation into a voltage variation proportional to said current variation, so that the voltage varies between a maximum value and a minimum value.

The minimum value of the voltage variation determined by the computer 40 corresponds, for example, to 0 volts and the maximum value corresponds to the second power supply voltage supplied by the power supply terminal B1.

Thus, the computer 40 reconstitutes the output signal normally transmitted by the sensor 10.

According to the example described above, the computer 40 is an engine control computer. The computer 40 is then configured to measure the duration between the rising or falling edges of the estimated output signal in order to determine the position and speed of rotation of the shaft to which the target is fixed, and notably in this case, to the crankshaft. Thus, the computer 40 is then able to control the injection of fuel into each combustion chamber, as a function of the speed command issued by the driver and of the determined speed of rotation of the shaft.

Furthermore, the computer 40 may also be able to transmit a power supply command to the power supply module 20, notably after detecting a short-circuit as described above, notifying the power supply module 20 that it should continue to supply power to the sensor 10. For example, the computer 40 is connected to the power supply module 20 by a serial peripheral interface known to a person skilled in the art.

The computer 40 comprises a processor, notably a microprocessor, able to implement a set of instructions that allows these functions to be performed.

FIG. 2 shows an embodiment of the vehicle according to the invention.

According to this example, the power supply module 20 comprises the current measurement device 30.

In addition, the vehicle comprises a control module 60 comprising the power supply module 20, the power supply terminal B1, the multiplexer 50, the ground M, the pull-up resistor Rt and the engine control computer 40. The pull-up resistor Rt in this case is therefore connected, on the one hand, to a power supply source and, on the other hand, to the wired communication link L2.

Furthermore, this type of control module 60 can be used for any system comprising a sensor able to generate an output signal, corresponding to an alternation between a high level and a low level, and comprising a transistor, the collector (or the drain) of which acts as an output signal transmitter, and a computer comprising a power supply module able to supply the sensor with electric power.

For example, the control module 60 as described above could be used in the gearbox control unit of the vehicle, notably for determining the position and/or the displacement of the shafts mounted in the gearbox.

1. A computer for a motor vehicle, said computer being able to be electrically connected to a sensor of the vehicle over a wired communication link in order to receive an output signal generated by said sensor, said sensor being electrically powered by a power supply module via a wired power supply link, the computer is configured for:
being electrically connected to a measurement device by a wired measurement exchange link, said measurement device being configured for measuring the variations in the electric current flowing through the wired power supply link;
detecting an anomaly on the wired communication link relating to a short-circuit between the wired power supply link and the wired communication link;
receiving, from the measurement device, measurements of the variations in the current flowing between the power supply module and the sensor when an anomaly is detected; and
estimating the output signal from the current variation measurements received over the wired measurement exchange link.

2. A motor vehicle comprising:
a) a sensor comprising a power supply connector and an output connector via which the sensor is able to generate an output signal;
b) a power supply module able to supply a power supply voltage, electrically connected to the power supply connector by a wired power supply link;
c) a current measurement device, able to measure the variation in current between the power supply module and the power supply connector; and
d) a computer as claimed in claim 1.

3. The vehicle as claimed in claim 2, comprising a multiplexer, said multiplexer comprising:
a) a first input electrically connected to the output connector;
b) a second input electrically connected to the current measurement device;
c) an output electrically connected to the computer;
d) a selection input connected to the computer;
the computer being configured for:
transmitting, when a short-circuit is detected, a command to the selection input of the multiplexer, notifying said multiplexer to connect the second input to the output of the multiplexer; and
receiving the variation in the current between the power supply module and the power supply connector measured by the measurement device and transmitted via the multiplexer.

4. The vehicle as claimed in any one of claim 2 or 3, comprising a pull-up resistor connected between a power supply terminal and the output connector of the sensor, said power supply terminal being able to supply a second power supply voltage with a value that is equal to the power supply voltage supplied by the power supply module.

5. The vehicle as claimed in claim 2, comprising a ground, the sensor comprising a ground connector electrically connected to the ground.

6. The vehicle as claimed in claim 5, wherein the sensor comprises a bipolar transistor, the collector of which is electrically connected to the output connector by a protective resistor and the transmitter of which is connected to the ground connector.

7. The vehicle as claimed in claim 5, wherein the sensor comprises a MOSFET transistor, the drain of which is electrically connected to the output connector by a protective resistor and the source of which is connected to the ground connector.

8. A method for estimating an output signal, implemented by a vehicle as claimed in claim 2, said method comprising:
a) detecting an anomaly on the wired communication link relating to a short-circuit between the wired power supply link and the wired communication link;
b) receiving measurements of the variation in the current flowing between the power supply module and the sensor when an anomaly is detected; and
c) estimating the output signal from the measurements of current variation received over the wired measurement exchange link.
